(19) United States
(12) Patent Application Publication
(10) Pub. No.: US 2026/0363475 A1
(43) Pub. Date: Nov. 19, 2026

(54) One-Piece Washable Rug

(71) Applicant: Ruggable LLC, Gardena, CA (US)

(72) Inventors: Robert Westphal Vera, New York, NY (US); Therese Mona-Lisa Germain, Los Angeles, CA (US); Ruggable LLC Wei-Ju Chen, Lakewood, CA (US)

(73) Assignee: Ruggable LLC, Gardena, CA (US)

(21) Appl. No.: 19/143,089

(22) PCT Filed: Dec. 19, 2023
(86) PCT No.: PCT/US23/84746

§ 371 Date: Jun. 25, 2025

Related U.S. Application Data
(60) Provisional application No. 63/476,168, filed on Dec. 19, 2022.

(51) Int. Cl. A47G 27/02; B32B 5/26; B32B 7/12; B32B 27/12; B32B 27/36

(52) U.S. Cl. CPC A47G 27/0281; A47G 27/0212; B32B 5/275; B32B 7/12; B32B 27/12; B32B 27/36; B32B 2250/03; B32B 2250/24; B32B 2262/0276; B32B 2262/148; B32B 2262/16; B32B 2274/00; B32B 2305/188; B32B 2307/7265; B32B 2307/744; B32B 2471/00

(57) ABSTRACT

A rug comprises several layers of material, including a polyester weave top surface, polyester scrim mesh for stability, polyurethane blend hot melt adhesive, and thermoplastic elastomer base layer. The rug is machine washable in standard home and commercial washing machines and maintains dimensional stability across multiple wash and dry cycles. The rug also provides slip resistance without the use of hazardous chemicals such as PFAS.

### BACKGROUND

### Technical Field

This disclosure relates to a washable and slip-resistant rug.

### Background Art

A number of washable rugs have been introduced to the market. Some washable rugs are relatively thin (e.g., with pile height of around 4 mm or less), and if they have small enough footprints (e.g., 3×5 feet or smaller), these rugs can be washed in many residential washing machines. Some washable rugs may be thicker (e.g., 5-7 mm pile height) or have larger footprints but can nevertheless still be washed using larger capacity commercial washers commonly available at laundromats. Most washable rugs can also be hand washed, such as with water and carpet cleaner, and hung to dry. Some washable rugs have slip-resistant backings made of materials such as rubber, PVC, latex, silicone, or TPE/TPR.

### SUMMARY

This disclosure relates to a rug with several useful qualities, including the following:

Washability: The rug is washable using standard residential washing machines, and can withstand repeated wash/dry cycles while maintaining dimensional stability—that is, without significant curling, warping, fraying, or wavy edges. Many existing washable rug products exhibit poor dimensional stability after just a few wash/dry cycles.

Slip Resistance: Many existing washable rug products do not have any slip-resistant qualities and must be used with a separate rug pad. Some existing washable rug products have integrated slip-resistant backings and do not need to be used with a separate rug pad, but many of these products have poor quality slip-resistant backings. Many of these rugs exhibit poor slip resistance, and can shift and be kicked around while on the floor, which presents a safety hazard. Many of these rugs also become uneven and “rippled” easily and need to be flattened out. Many rugs have backings that easily deteriorate over time, especially with repeated exposure to water and heat through wash and dry cycles.

Safely Spill-Proof: Many existing rug products are treated with chemical coatings to give them a degree of water resistance, but these coatings may contain toxic PFAS—also known as “forever chemicals”—that do not naturally break down and may be hazardous to human health. Many existing products are not water resistant without these coatings. If a spill or pet stain occurs, liquid may seep through the rug to the bottom of the floor.

### BRIEF DESCRIPTION OF THE DRAWINGS

FIG. 1 shows the layers of a washable rug according to an embodiment.

### DETAILED DESCRIPTION

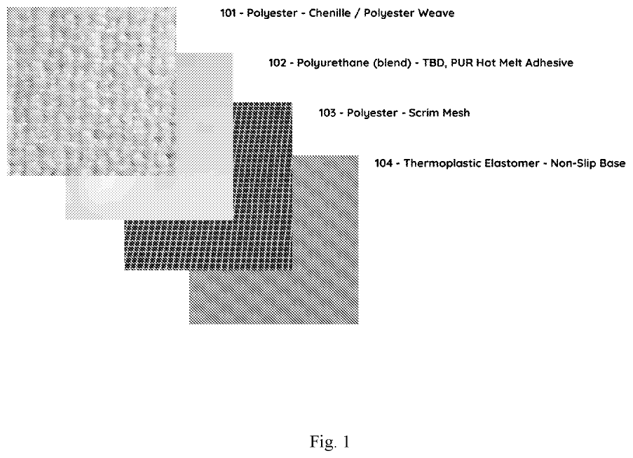

The following discussion is made with reference to FIG. 1.

In an embodiment, a washable rug comprises several layers 101, 102, 103, and 104, which are described in more detail below. It would be appreciated by a skilled artisan from the disclosure herein that embodiments or implementations may arrange the layers in a different order, use a different material for a particular layer, use additional or fewer layers, have liquid resistant layers that reduce rather than eliminate liquid passthrough, or make other changes, all without departing from the spirit or scope of this disclosure.

### Layer 1: Polyester—Chenille/Polyester Weave

The first layer 101 of the rug comprises a polyester weave made using a polyester filament as the warp and a polyester chenille yarn as the weft. The preferred values for attributes of the warp, weft, and the overall weave are as follows:

| | | | Most |
|---|---|---|---|
| | | More Preferred | Preferred |
| Attribute | Preferred Values | Values | Values |
| Weight of the | around 196-560 | around 266-294 | around 280 |
| weave (GSM) | | | |
| Warp density | around 32.3-57 | around 36.86-39.14 | around 38 |
| (threads per | | | |
| inch) | | | |
| Yarn size of | around 4.25-10 Nm | around 4.75-5.25 | around 5 |
| the weft (Nm) | | | |
| Number of | around 680-1600 | 760-840 | around 800 |
| twists in | | | |
| the weft | | | |
| (twists | | | |
| per meter) | | | |

It has been found that a layer 101 made to the above specifications is optimized to withstand up to 35,000 cycles in Martindale abrasion testing. It is also optimized for surface treatment and flexibility.

Although disclosed with specific reference to materials and manufacturing processes, an artisan will recognize from the disclosure herein different embodiments with different or alternative materials and/or manufacturing processes can be used. For example, materials such as acrylic, modacrylic, polypropylene, rayon, recycled polyester, and nylon may be used instead of or in conjunction with the above.

### Layer 2—Polyurethane (Blend)—TBD, PUR Hot Melt Adhesive

The second layer 102 comprises an adhesive optimized for bonding synthetic fabric materials. The adhesive bonds together the other layers of the rug. In some embodiments, the selected adhesive material should be flexible and should retain its adhesive properties to keep the layers of the rug together through rolling and folding and multiple wash and dry cycles. The adhesive may be a 35 GSM polyurethane (PUR) hot melt adhesive comprised of NEL-1016, NCO-terminated polyurethane. This adhesive has been found to withstand heat exposure during the production process of the rug as well as through multiple wash and dry cycles.

Although disclosed with specific reference to the blend above, an artisan will recognize from the disclosure herein different or alternative bonding materials and/or manufacturing processes that adhere the layers to each other. For example, materials such as thermoplastic polyurethane adhesive or a polyurethane (PUR) hot melt adhesive comprised of about 85-100% isocyanate prepolymer mixed with methylene biphenyl diisocyanate may be used instead of or in conjunction with the above. Another example of an adhesive that may be used is a mixture of thermoplastic styrene-butadiene rubber, mineral oil, petroleum resin, and polyethylene wax.

### Layer 3: Polyester—Scrim Mesh

The third layer 103 comprises a finely woven, lightweight polyester mesh cloth used to reinforce the surface material to reduce skewing/bowing after surface treatment. This optional layer improves stability of the overall rug and improves the bonding of the top layer 101 to the TPE layer 104 discussed below.

The preferred values for attributes of the polyester scrim mesh are as follows:

| | | More Preferred | Most Preferred |
|---|---|---|---|
| Attribute | Preferred Values | Values | Values |
| Weight (GSM) | around 106.25- | around 118.75- | around 125 |
| | 143.75 | 131.25 | |

Although disclosed with specific reference to materials and manufacturing processes, an artisan will recognize from the disclosure herein different embodiments with different or alternative materials and/or manufacturing processes can be used. For example, a thermoplastic polyurethane material, such as 22 GSM TPU, may be used instead of or in conjunction with the above. Such material may be used to provide additional stability to the rug by preventing or reducing corner curling, torquing, or edge waviness (lifting), especially over multiple wash and dry cycles. Such material would also provide protection against liquid penetration.

### Layer 4—Thermoplastic Elastomer—Cushioned/Non-Slip Base

The fourth layer 104 comprises a composition using extruded thermoplastic elastane (TPE). This material has been found to exhibit high slip resistance, with a slip resistance coefficient of friction at 1.6 kg on various floor substrates (vinyl, ceramic tile, hardwood floor, and more). This material thus provides slip-resistance while avoiding the use of hazardous chemicals such as PFAS. This layer may also be made to have a certain thickness to provide a cushioned “foot feel” for someone who is stepping on the rug. This TPE layer also prevents liquids penetration so that spills would not seep through to the rug.

The preferred values for attributes of the TPE layer are as follows:

| | | | Most |
|---|---|---|---|
| | Preferred | More Preferred | Preferred |
| Attribute | Values | Values | Values |
| Thickness | around 0.3-17 | around 1.75-12.25 | around 1.5-12 |
| (mm) | | | |
| Weight (GSM) | around 168-1400 | around 532-735 | around 560-700 |
| Slip-resistance | around 1-2.2 kg | around 1.3-1.9 kg | around 1.6 kg |
| coefficient | | | |
| (kg) | | | |

It has been found that a layer 104 made to the above specifications has a number of desirable qualities. It is highly malleable so that a 6 foot by 9 foot rug using this material can fit easily in a standard 3.8 cubic feet residential washer with an agitator. The TPE is extruded at a speed and formulation that provides for substantial slip resistance that score satisfies ASTM F609 Slip indexes and the National Floor and Safety Institute index. A 1.6 kg slip-resistance coefficient is considered high-traction based on Bureau Veritas standards.

### The Overall Rug

The rug described above comprises several layers of material bonded together using adhesive that is activated by the application of pressure and heat. Once bonded together, embodiments of the rug resist deformation such as shrinkage, curling (including at its corners), warping, and torquing.

The entire rug is machine washable. The rug is dimensionally stable with no surface change, construction distortion, edge waving, warping or corner curling after multiple wash and dry cycles in residential and commercial washers and dryers. The finished cover product is malleable, lightweight, and can be folded, rolled, and compressed to safely wash and dry multiple times.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including, “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure and the principles and the novel features disclosed herein.

1. A machine-washable rug comprising:
a top layer comprising a polyester weave;
a polyester scrim mesh layer; and
a thermoplastic elastomer base layer.

2. The rug of claim 1, further comprising an adhesive applied to bond the layers together.

3. The rug of claim 1, wherein the top layer is woven from a polyester filament warp and a polyester chenille yarn weft.

4. The rug of claim 1, wherein the polyester scrim mesh layer provides additional stability to the rug.

5. The rug of claim 1, wherein the thermoplastic elastomer base layer is slip-resistant and prevents liquid penetration.

6. The rug of claim 5, wherein the thermoplastic elastomer base layer provides a cushioned foot feel.
